(19) United States
(12) Patent Application Publication
(10) Pub. No.: US 2009/0254471 A1
(43) Pub. Date: Oct. 8, 2009

(54) SETTLEMENT OF FUTURES CONTRACTS IN FOREIGN CURRENCIES

(76) Inventors: Peter Stuart SEIDEL, Beverly Hills, CA (US); Peter Joseph Kovac, Santa Monica, CA (US)

Correspondence Address: KATTEN MUCHIN ROSENMAN LLP;(C/O PATENT ADMINISTRATOR), 2900 K STREET NW, SUITE 200, WASHINGTON, DC, 20007-5118, US

(21) Appl. No.: 12/062,140

(22) Filed: Apr. 3, 2008

(51) Int. Cl. G06Q 40/00

(52) U.S. Cl. 705/37

(57) ABSTRACT

A method and system are provided for executing a transaction relating to a first futures contract. The first futures contract involves a tradable asset, such as crude oil or another commodity, and a first contract price and a first settlement price expressed in a first currency, such as U.S. dollars. The first settlement price is updated on a periodic basis, typically daily. The method involves providing a second futures contract having an underlying instrument that includes the first futures contract. The second futures contract includes a second latest possible delivery date and a second contract price and a second settlement price that are denominated in a second currency. The second settlement price is updated periodically. A periodic mark-to-market operation credits or debits a buyer of the second futures contract based on the periodic update to the second settlement price. Delivery of the second contract occurs when the buyer pays the current second settlement price in the second currency and receives the first futures contract. Then, delivery of the first futures contract is completed by delivering either the tradable entity or a financial equivalent of the tradable entity based on the current first settlement price.

### BACKGROUND OF THE INVENTION

1. Field of the Invention

The present invention relates to financial markets and futures contracts for tradable assets, such as commodities or other financial instruments. More particularly, the invention relates to a system and method for facilitating pricing and trading of futures contracts in a different currency than the one in which those same contracts are ordinarily traded, thereby enabling a potential buyer to use a preferred foreign currency.

2. Related Art

In the financial world, a common type of derivatives contract is a futures contract. A futures contract is a standardized contract for delivery of a commodity, stock, financial instrument, or cash-equivalent thereof or of a given index at a time in the future. The purpose of a futures contract is to provide a consistent and exchange-tradable vehicle for investors and hedgers to easily manage risk. Some of the common features of futures contracts include: Standardized contract specifications, a last trading date, using a clearing house to clear the contracts, relatively low margin requirements due to the financial stability of the clearinghouse, and the cost of carry reflected in the price of the contract.

A typical futures contract will trade at a premium or discount to the actual level of the underlying instrument. This premium or discount is known as the basis, and is the result of the cost of carry. The cost of carry for a futures contract is what it would cost to hold or store the underlying over the length of the contract. Typically, the longer to the delivery date of the futures contract, the greater this cost of carry will be. For example, if one were to hold corn in a silo for delivery in a few months, one would have to pay for the storage facilities during that time period. This cost of carry is implicit in the futures contract, that is, it is added to the price of the futures contract, resulting in the basis.

There are exchanges, such as the New York Mercantile Exchange (NYMEX) and the Chicago Mercantile Exchange (CME), that trade many futures contracts for which the underlying instrument is a commodity, such as crude oil. For example, the NYMEX has two standard types of futures contracts for light sweet crude oil, known as the West Texas Intermediate (WTI) contract and the Brent contract. Typically, these and other types of futures contracts that are traded on exchanges based in the United States of America use U.S. dollars as the currency upon which the contract is based.

In recent years, foreign investors, speculators, and hedgers have become a significant part of the market for futures contracts listed on U.S. exchanges, and investors, speculators, and hedgers in the U.S. have become a significant part of the market for futures contracts listed on non-U.S. exchanges. For these market participants, volatility in foreign exchange and currency markets makes the value of the underlying investment instruments uncertain, due to price fluctuations in the relative value of the U.S. dollar. Therefore, there is a need to enable foreign market participants to enter into futures contracts offered by exchanges based in the U.S. while protecting those same market participants from being subjected to foreign exchange rate fluctuations. Likewise, there is a corresponding need to enable U.S. market participants to enter into futures contracts offered by exchanges based outside the U.S. while protecting those same market participants from being subjected to foreign exchange rate fluctuations.

### SUMMARY OF THE INVENTION

In one aspect, the invention provides a method for executing a transaction relating to a first futures contract. The first futures contract includes a first latest possible delivery date and a first predetermined amount of a tradable asset, a first contract price, and a first settlement price. Each of the first contract price and the first settlement price is expressed as a respective amount of a first currency, such as U.S. dollars. The first settlement price is updated on a periodic basis, typically a daily basis. The method comprises the steps of: providing a second futures contract to a buyer, the second futures contract having an underlying instrument that comprises the first futures contract, wherein the second futures contract includes a second latest possible delivery date, a second contract price, and a second settlement price, each of the second contract price and the second settlement price being expressed as a respective amount of a second currency, typically a selected foreign currency, the second settlement price being updated on a periodic basis, and the second latest possible delivery date occurring on or before the first latest possible delivery date; performing a periodic mark-to-market operation whenever the second settlement price is updated by either crediting or debiting a buyer account based on the corresponding updated second settlement price; delivering the second futures contract on or before the second latest possible delivery date by providing the first futures contract to the buyer in exchange for a payment from the buyer of a current second settlement price; and delivering the first futures contract on or before the first latest possible delivery date by delivering one or the other of the first predetermined amount of the tradable asset to the buyer and a current first settlement price.

The tradable asset may include a commodity, such as crude oil, or a stock, a stock index, or a financial index. The first futures contract may include a standard WTI contract or a standard Brent contract. The second latest possible delivery date may occur one day prior to the first latest possible delivery date. Each of the first currency and the second currency may be selected from the group consisting of U.S. dollars, European euros, Canadian dollars, U.K. pounds sterling, Australian dollars, New Zealand dollars, Swiss francs, Norwegian kroner, Swedish kronor, and Japanese yen.

In another aspect, the invention provides a method of facilitating a trade involving a first futures contract. The first futures contract includes a first latest possible delivery date and a first predetermined amount of a tradable asset, a first contract price, and a first settlement price. Each of the first contract price and the first settlement price is expressed as a respective amount of a first currency, such as U.S. dollars. The first settlement price is updated on a periodic basis, typically a daily basis. The method comprises the steps of: providing a second futures contract to a buyer, the second futures contract having an underlying instrument that comprises the first futures contract, wherein the second futures contract includes a second latest possible delivery date, a second contract price, and a second settlement price, each of the second contract price and the second settlement price being expressed as a respective amount of a second currency, typically a selected foreign currency, the second settlement price being updated on a periodic basis, and the second latest possible delivery date occurring on or before the first latest possible delivery date; performing a periodic mark-to-market operation whenever the second settlement price is updated by either crediting or debiting a buyer account based on the corresponding updated second settlement price; delivering the second futures contract on or before the second latest possible delivery date by providing the first futures contract to the buyer in exchange for a payment from the buyer of a current second settlement price; and delivering the first futures contract on or before the first latest possible delivery date by delivering one or the other of the first predetermined amount of the tradable asset to the buyer and a current first settlement price.

The tradable asset may include a commodity, such as crude oil, or a stock, a stock index, or a financial index. The first futures contract may include a standard WTI contract or a standard Brent contract. The second latest possible delivery date may occur one day prior to the first latest possible delivery date. Each of the first currency and the second currency may be selected from the group consisting of U.S. dollars, European euros, Canadian dollars, U.K. pounds sterling, Australian dollars, New Zealand dollars, Swiss francs, Norwegian kroner, Swedish kronor, and Japanese yen.

In yet another aspect, the invention provides a system for executing a transaction relating to a first futures contract. The first futures contract includes a first latest possible delivery date and a first predetermined amount of a tradable asset, a first contract price, and a first settlement price. Each of the first contract price and the first settlement price is expressed as a respective amount of a first currency, such as U.S. dollars. The first settlement price is updated on a periodic basis, typically a daily basis. The system comprises a server at which the first futures contract is actively traded and an interface in communication with the server, the interface being configured to enable a buyer to enter into the first futures contract. The server is configured to: provide a second futures contract to a buyer, the second futures contract having an underlying instrument that comprises the first futures contract, wherein the second futures contract includes a second latest possible delivery date, a second contract price, and a second settlement price, each of the second contract price and the second settlement price being expressed as a respective amount of a second currency, typically a selected foreign currency, the second settlement price being updated on a periodic basis, and the second latest possible delivery date occurring on or before the first latest possible delivery date; perform a periodic mark-to-market operation whenever the second settlement price is updated by either crediting or debiting a buyer account based on the corresponding updated second settlement price; deliver the second futures contract on or before the second latest possible delivery date by providing the first futures contract to the buyer in exchange for a payment from the buyer of a current second settlement price; and deliver the first futures contract on or before the first latest possible delivery date by delivering one or the other of the first predetermined amount of the tradable asset to the buyer and a current first settlement price.

The tradable asset may include a commodity, such as crude oil, or a stock, a stock index, or a financial index. The first futures contract may include a standard WTI contract or a standard Brent contract. The second latest possible delivery date may occur one day prior to the first latest possible delivery date. Each of the first currency and the second currency may be selected from the group consisting of U.S. dollars, European euros, Canadian dollars, U.K. pounds sterling, Australian dollars, New Zealand dollars, Swiss francs, Norwegian kroner, Swedish kronor, and Japanese yen.

### BRIEF DESCRIPTION OF THE DRAWINGS

FIG. 1 illustrates a block diagram of a system for executing a transaction relating to a futures contract according to a preferred embodiment of the invention.

FIG. 2 is a flow chart that illustrates a method of executing a transaction relating to a futures contract according to a preferred embodiment of the invention.

### DETAILED DESCRIPTION OF THE INVENTION

The present invention provides a system and a method for enabling an investor, speculator, or hedger to enter into a futures contract that uses a first currency, such as U.S. dollars, while designating a preferred second (e.g., foreign) currency upon which to base the futures contract. In this manner, the investor is essentially able to substitute the desired second currency for the first currency and thereby remove risk relating to relative volatility of the first currency over the term of the futures contract.

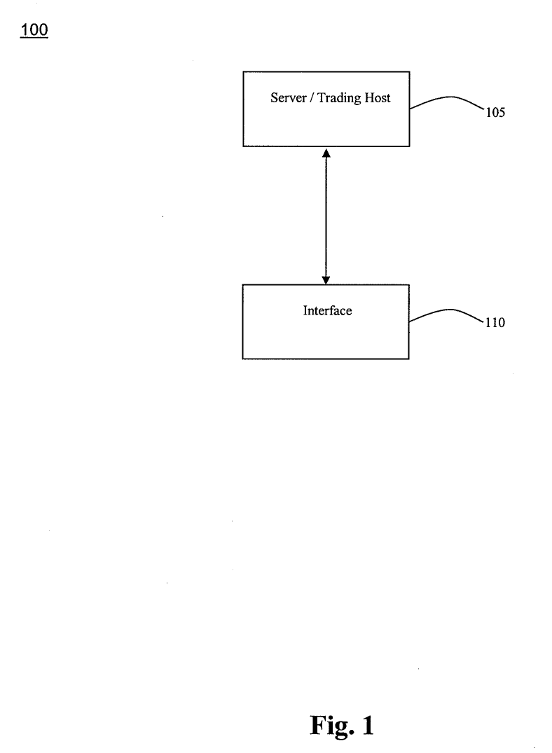

Referring to FIG. 1, a block diagram illustrates an electronic trading system 100 according to a preferred embodiment of the present invention. The system includes one or more servers 105, also referred to as a trading host 105, and one or more interfaces 110. The trading host 105 is preferably implemented by the use of one or more general purpose computers, such as, for example, a Sun Microsystems F15k. Each interface 110 is also preferably implemented by the use of one or more general purpose computers, such as, for example, a typical personal computer manufactured by Dell, Gateway, or Hewlett-Packard. Each of the trading host 105 and the interface 110 can include a microprocessor. The microprocessor can be any type of processor, such as, for example, any type of general purpose microprocessor or microcontroller, a digital signal processing (DSP) processor, an application-specific integrated circuit (ASIC), a programmable read-only memory (PROM), or any combination thereof. The trading host may use its microprocessor to read a computer-readable medium containing software that includes instructions for carrying out one or more of the functions of the trading host 105, as further described below.

Each of the trading host 105 and the interface 110 can also include computer memory, such as, for example, random-access memory (RAM). However, the computer memory of each of the trading host 105 and the interface 110 can be any type of computer memory or any other type of electronic storage medium that is located either internally or externally to the trading host 105 or the interface 110, such as, for example, read-only memory (ROM), compact disc read-only memory (CDROM), electro-optical memory, magneto-optical memory, an erasable programmable read-only memory (EPROM), an electrically-erasable programmable read-only memory (EEPROM), or the like. According to exemplary embodiments, the respective RAM can contain, for example, the operating program for either the trading host 105 or the interface 110. As will be appreciated based on the following description, the RAM can, for example, be programmed using conventional techniques known to those having ordinary skill in the art of computer programming. The actual source code or object code for carrying out the steps of, for example, a computer program can be stored in the RAM. Each of the trading host 105 and the interface 110 can also include a database. The database can be any type of computer database for storing, maintaining, and allowing access to electronic information stored therein. The host server 105 preferably resides on a network, such as a local area network (LAN), a wide area network (WAN), or the Internet. The interface 110 preferably is connected to the network on which the host server resides, thus enabling electronic communications between the trading host 105 and the interface 110 over a communications connection, whether locally or remotely, such as, for example, an Ethernet connection, an RS-232 connection, or the like.

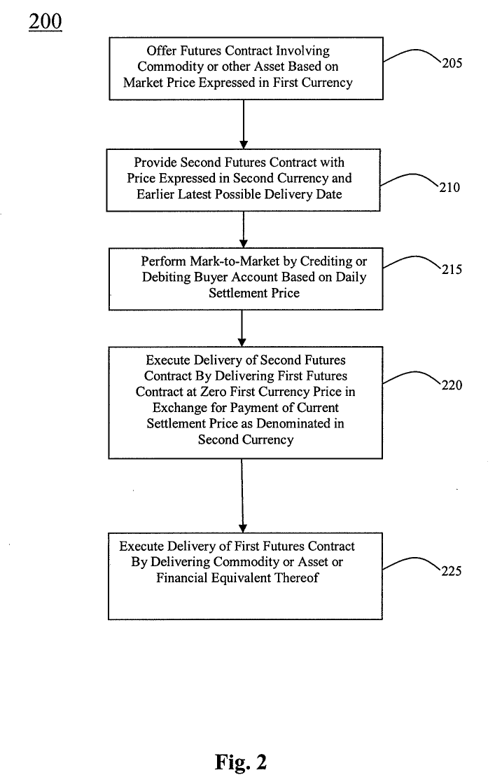

Referring to FIG. 2, a flow chart 200 illustrates a process that is executed by the system 100 for facilitating trading of futures contracts in foreign currencies, according to a preferred embodiment of the present invention. In the first step 205, a first futures contract involving a tradable asset, such as a stock or a commodity, is offered at a market price that is expressed in a first currency, typically U.S. dollars. The first futures contract also includes a first settlement price which is also denominated in the first currency and is updated on a periodic basis, typically on a daily basis. Usually, the first settlement price is roughly equivalent to a prevailing market price for the tradable asset at the end of each trading day. In the next step 210, a second futures contract is provided that includes the first futures contract as the underlying instrument. Notably, the second futures contract may include an integral number (e.g., 2, 3, 10, etc.) of the first futures contract as the underlying instrument; however, in a preferred embodiment, the integral number is equal to one.

The second futures contract is denominated in a preferred second currency, typically a foreign currency, such as, for example, European euros, Canadian dollars, U.K. pounds sterling, Australian dollars, New Zealand dollars, Swiss francs, Norwegian kroner, Swedish kronor, South African rand, Hong Kong dollars, Singapore dollars, Brazilian real, Russian rubles, Chinese renminbi, Korean won, Indian rupees, or Japanese yen. Preferably, a market participant that is interested in entering the futures contract may choose any foreign currency that is preferred by that investor. Alternatively, an approved list of specific foreign currencies may be provided by the exchange, and the investor may choose a preferred foreign currency from the approved list. The contract price for the second futures contract is expressed as an amount of the second currency that typically has a value that is substantially equivalent to the value of the market price as expressed in the first currency.

Although each of the first and second futures contracts typically includes a last trading date, there is also a latest possible delivery date for each contract, which may or may not coincide with its last trading date. Typically, there is a delivery period which may begin several days in advance of the last trading date, and which may end up to several days after the last trading date. In a preferred embodiment of the invention, the latest possible delivery date of the second contract is set to occur on or before the latest possible delivery date of the original futures contract. In a more preferred embodiment of the invention, the latest possible delivery date of the second futures contract occurs one day prior to the latest possible delivery date of the first futures contract. An investor preferring to deal in the second currency agrees to enter the second futures contract.

In step 215, a mark-to-market operation is performed. At regular intervals, typically once per day, the issuer of each futures contract (i.e., typically, an exchange) determines a settlement price for each futures contract. Each settlement price is typically based on an average price of the last trades of that period. A variation margin is computed based on either the original contract price, if the contract was purchased within the last regular interval for determining the settlement price, or the previously determined settlement price, if the contract had been purchased prior to the most recent update of the settlement price. The variation margin is equal to the difference between the current settlement price and either the contract price or the previous settlement price. The mark-to-market operation entails either crediting the buyer in the amount of a positive variation margin, or debiting the buyer in the amount of a negative variation margin.

Step 220 occurs on or before the latest possible delivery date of the second futures contract. In this step, the exchange executes the delivery of the second futures contract by delivering the first futures contract in exchange for a payment from the buyer to the seller in the amount of the current settlement price, as expressed in the second currency. Typically, even though the first futures contract has a contract price that is expressed in terms of the first currency, the effective contract price of the first futures contract is zero, as expressed in the first currency, in view of the payment of the settlement price in the second currency. In an alternative embodiment, the buyer may be required to pay an additional amount as expressed in the first currency.

Finally, step 225 occurs on or before the latest possible delivery date of the original futures contract. In this final step of the method, the exchange executes the delivery of the original futures contract by delivering either the physical commodity itself or an amount of the first currency that is equivalent to the current settlement price as expressed in the first currency. Thus, the investor has now received either the physical delivery of the desired commodity in exchange for the settlement price as expressed in the preferred foreign currency, or the equivalent market value of that commodity. Because the investor never prices the futures contract in terms of the first currency, nor transacts in the first currency (with the possible exception of any transactions that may occur during the short interval after delivery of the second contract and prior to delivery of the first contract, transactions which will generally net out over the interval), the investor is completely isolated from any volatility associated with the first currency in relation the first futures contract.

Of course, as is often the case with futures contracts, the investor may decide to roll a current futures contract over to a new futures contract having a later last trading date, or a later latest possible delivery date, or both. This is accomplished by liquidating the current futures contract and simultaneously entering into a new futures contract having a later delivery month. As with any futures contract, this type of transaction may occur at any point in time prior to the last day of trading of the current futures contract (i.e., referring again to FIG. 2, after step 210 and prior to step 220). In this event, steps 220 and 225 are simply deferred until the respective last trading dates or latest possible delivery dates of the corresponding new replacement futures contracts.

The present invention provides an arbitrageur with a capability of no-risk arbitrage between the second futures contract, which is denominated in the preferred second currency, and the first futures contract, which is denominated in the first currency. The existence of an arbitrage condition allows the arbitrageur to use a precise mathematical relationship to price the second futures contract based on the first futures contract, thus leveraging the liquidity and market share of the tradable asset. For example, an arbitrageur could price a WTI futures contract in euros solely based on the current exchange rate between the U.S. dollar and the euro and the price of the U.S. WTI contract, thus ensuring that a liquid and ready market can be made immediately following the launch of the new euro-based WTI contract.

Moreover, the existence of an arbitrage condition allows an investor in the second futures contract an alternative mechanism for precisely and completely hedging his risk, regardless of whether the market in the second futures contract is sufficiently liquid at the time. For example, if the purchaser of a euro-based WTI contract desires to sell his contract after normal trading hours in Europe, but is unable to find a ready market for the desired sale, he may then turn to the U.S. market, where the corresponding dollar-denominated futures contract is being actively traded at that time. By selling a dollar-denominated futures contract and executing a foreign currency exchange transaction, the investor can close his position with zero additional risk, because his euro-based WTI contract will be converted to a dollar-denominated contract upon delivery, thereby offsetting his short position in the dollar-denominated contract.

Crude oil is perhaps the most widely traded commodity on world commodity exchanges. One popular type of futures contract for light sweet crude oil is known as the WTI contract, which is traded on the NYMEX exchange. A second popular type of futures contract for light sweet crude oil is known as the Brent contract, which is also traded on the NYMEX exchange. Appendix A, which is incorporated by reference herein in its entirety, provides a description of some of the specific aspects of certain futures contracts involving light sweet crude oil as offered on the NYMEX exchange.

The following example is provided to illustrate a method according to a preferred embodiment of the present invention: It is supposed that a German investor is interested in purchasing a WTI contract on the NYMEX exchange. In particular, on Mar. 17, 2008, the German investor desires to purchase a monthly futures contract for May 2008, which provides for delivery of 1000 barrels of oil. The prevailing market price of WTI oil on Mar. 17, 2008 is $105/barrel. Therefore, the notional value of the commodity underlying the desired contract is $105,000. However, the German investor is leery of recent fluctuations in the U.S. dollar, and therefore would prefer to enter the futures contract in euros. As of Mar. 17, 2008, the prevailing exchange rate between U.S. dollars and euros is $1.50/euro. Therefore, the German investor agrees to enter a euro-denominated WTI futures contract for a price of 105,000/1.50=70,000 euros, with a last trading date of Apr. 21, 2008, i.e., one day prior to the Apr. 22, 2008 last trading date of the standard monthly WTI contract. It is noted that for purposes of this example, the last trading date is assumed to be equivalent to the latest possible delivery date for the second futures contract.

As the time passes over April of 2008, it is assumed for purposes of this example that the price of oil rises from $105/barrel to $115/barrel. In addition, over that same interval, it is assumed for purposes of this example that the value of the U.S. dollar decreases relative to the euro, from $1.50/euro to $1.52/euro. So, at the end of each trading day, a settlement price is computed by the exchange in both U.S. dollars and euros, and the German investor's account is either credited or debited, in euros, based on that day's settlement price as compared with the previous day's settlement price. Finally, on Apr. 21, 2008, the German investor's contract is worth 1000*$115=$115,000/$1.52=75,657.89 euros, which represents an increase in value of 5,657.89 euros since he entered the euro-denominated futures contract. Therefore, as of that date, the German investor's account has been credited by a net of 5,657,89 euros, and he is now required to pay 75,657.89 euros in exchange for a WTI contract for 1000 barrels of oil that will expire on Apr. 22, 2008. Then, upon delivery of the original futures contract (which, for a standard US-dollar denominated WTI contract, typically occurs a few days after its last trading date), the investor receives a physical delivery of the 1000 barrels of oil. In this manner, by correctly guessing that the value of oil would rise over the interval of the futures contract, the investor has received the desired oil at the lower price that was prevailing at an earlier time, similar as any conventional futures contract. In addition, the investor has effectively protected himself from fluctuations in the value of the U.S. dollar by executing the transaction in euros, according to a preferred embodiment of the present invention.

The exchange may choose to provide margin offsets to investors holding offsetting positions in the first and second futures contracts. For example, the exchange may choose to provide a credit to an investor who has bought the second futures contract and sold the first futures contract, thereby creating a position that bears no pricing risk in relation to the first tradable asset. The provision of such a credit would reduce the costs for arbitrageurs to trade the second futures contract and would thus promote liquidity and trading volume in the market for the second contract.

Furthermore, the exchange may choose to provide additional margin offsets to investors holding offsetting positions in the first and second futures contracts, and in the first and second currencies. For example, the exchange may choose to provide a credit to an investor who has bought the second futures contract and sold the first futures contract while buying the second currency and selling the first currency, thereby creating a position that bears no pricing risk in relation to the first tradable asset or the second currency. The provision of such a credit would reduce the costs for arbitrageurs to trade the second contract and would thus promote liquidity and trading volume in the market for the second futures contract.

In an alternative embodiment of the invention, either or both of the first and second futures contracts may include a contract price that is denominated in a selected commodity, such as gold or silver, instead of a currency. In this manner, the selected commodity may be used as a replacement for a currency.

In another alternative embodiment of the invention, the first and second futures contracts may utilize the same currency. In this embodiment, because the first futures contract acts as the underlying instrument for the second futures contract, a future on a futures contract is manifested. This alternative embodiment may be used advantageously, for example, when a bundle of first futures contracts is used as the underlying instrument for the second futures contract. For example, a “summer strip” of crude oil futures contracts may serve as a bundle of first futures contracts, e.g., a Summer 2008 contract may comprise a future on the bundle of April, May, June, July, August, September, and October crude futures. Such a bundle may be of interest to a trader, since he pays commissions on only one contract instead of seven when he buys this.

In another alternative embodiment of the invention, one or both of the first and second futures contracts may be offered and/or traded in an open-outcry trading environment. In yet another alternative embodiment of the invention, either or both of the first and second futures contracts may be offered and/or traded based on a telephone system for communicating offers and bids for each respective futures contract.

In another alternative embodiment of the invention, the mark-to-market operation may occur at irregular intervals or be omitted completely. For example, if the mark-to-market operation were omitted, the second contract would be delivered by providing the first futures contract to the buyer in exchange for a payment from the buyer of the original second contract price.

While the present invention has been described with respect to what is presently considered to be the preferred embodiment, it is to be understood that the invention is not limited to the disclosed embodiments. To the contrary, the invention is intended to cover various modifications and equivalent arrangements included within the spirit and scope of the appended claims. For example, instead of crude oil, any commodity that is commonly traded on commodities markets may be the subject of a futures contract according to an embodiment of the present invention. In addition, instead of a physical commodity, any tradable asset that is commonly the underlying asset of a futures contract traded on an exchange may be used according to an embodiment of the present invention. Further, instead of U.S. dollars and euros, any foreign currency that is preferred by market participants and accepted by the exchange clearing house may be used according to an embodiment of the present invention, and any futures contract that is ordinarily based on a first currency other than U.S. dollars may also be used according to an embodiment of the present invention. For example, a London commodities exchange may offer futures contracts based on the British pound sterling, and the investor's preferred foreign currency may be the U.S. dollar. The scope of the following claims is to be accorded the broadest interpretation so as to encompass all such modifications and equivalent structures and functions.

What is claimed is:

1. A method for executing a transaction relating to a first futures contract, the first futures contract including a first latest possible delivery date and a first predetermined amount of a tradable asset, a first contract price, and a first settlement price, each of the first contract price and the first settlement price being expressed as a respective amount of a first currency, the first settlement price being updated on a periodic basis, and the method comprising the steps of:
providing a second futures contract to a buyer, the second futures contract having an underlying instrument that comprises the first futures contract, wherein the second futures contract includes a second latest possible delivery date, a second contract price, and a second settlement price, each of the second contract price and the second settlement price being expressed as a respective amount of a second currency, the second settlement price being updated on a periodic basis, and the second latest possible delivery date occurring on or before the first latest possible delivery date;
when the second settlement price is updated, performing a periodic mark-to-market operation by either crediting or debiting a buyer account based on the corresponding updated second settlement price;
delivering the second futures contract on or before the second latest possible delivery date by providing the first futures contract to the buyer in exchange for a payment from the buyer of a current second settlement price; and
delivering the first futures contract on or before the first latest possible delivery date by delivering one or the other of the first predetermined amount of the tradable asset to the buyer and a current first settlement price.

2. The method of claim 1, wherein the tradable asset comprises a commodity.

3. The method of claim 2, wherein the commodity comprises crude oil.

4. The method of claim 3, wherein the first futures contract comprises a standard WTI contract.

5. The method of claim 3, wherein the first futures contract comprises a standard Brent contract.

6. The method of claim 1, wherein the second latest possible delivery date occurs one day prior to the first latest possible delivery date.

7. The method of claim 1, wherein the tradable asset comprises at least one asset selected from the group consisting of a stock, a stock index, and a financial index.

8. The method of claim 1, wherein each of the first currency and the second currency is selected from the group consisting of U.S. dollars, European euros, Canadian dollars, U.K. pounds sterling, Australian dollars, New Zealand dollars, Swiss francs, Norwegian kroner, Swedish kronor, and Japanese yen.

9. A method of facilitating a trade involving a first futures contract, the first futures contract including a first latest possible delivery date and a first predetermined amount of a tradable asset, a first contract price, and a first settlement price, each of the first contract price and the first settlement price being expressed as a respective amount of a first currency, the first settlement price being updated on a periodic basis, and the method comprising the steps of:
providing a second futures contract to a buyer, the second futures contract having an underlying instrument that comprises the first futures contract, wherein the second futures contract includes a second latest possible delivery date, a second contract price, and a second settlement price, each of the second contract price and the second settlement price being expressed as a respective amount of a second currency, the second settlement price being updated on a periodic basis, and the second latest possible delivery date occurring on or before the first latest possible delivery date;
when the second settlement price is updated, performing a periodic mark-to-market operation by either crediting or debiting a buyer account based on the corresponding updated second settlement price;
delivering the second futures contract on or before the second latest possible delivery date by providing the first futures contract to the buyer in exchange for a payment from the buyer of a current second settlement price; and
delivering the first futures contract on or before the first latest possible delivery date by delivering one or the other of the first predetermined amount of the tradable asset to the buyer and a current first settlement price.

10. The method of claim 9, wherein the tradable asset comprises a commodity.

11. The method of claim 10, wherein the commodity comprises crude oil.

12. The method of claim 11, wherein the first futures contract comprises a standard WTI contract.

13. The method of claim 11, wherein the first futures contract comprises a standard Brent contract.

14. The method of claim 9, wherein the second latest possible delivery date occurs one day prior to the first latest possible delivery date.

15. The method of claim 9, wherein the tradable asset comprises at least one asset selected from the group consisting of a stock, a stock index, and a financial index.

16. The method of claim 9, wherein each of the first currency and the second currency is selected from the group consisting of U.S. dollars, European euros, Canadian dollars, U.K. pounds sterling, Australian dollars, New Zealand dollars, Swiss francs, Norwegian kroner, Swedish kronor, and Japanese yen.

17. A system for executing a transaction relating to a first futures contract, the first futures contract including a first latest possible delivery date and a first predetermined amount of a tradable asset, a first contract price, and a first settlement price, each of the first contract price and the first settlement price being expressed as a respective amount of a first currency, the first settlement price being updated on a periodic basis, and the system comprising:
a server at which the first futures contract is actively traded; and
an interface in communication with the server, the interface being configured to enable a buyer to enter into the first futures contract,
wherein the server is configured to:
provide a second futures contract to a buyer, the second futures contract having an underlying instrument that comprises the first futures contract, wherein the second futures contract includes a second latest possible delivery date, a second contract price, and a second settlement price, each of the second contract price and the second settlement price being expressed as a respective amount of a second currency, the second settlement price being updated on a periodic basis, and the second latest possible delivery date occurring on or before the first latest possible delivery date;
when the second settlement price is updated, perform a periodic mark-to-market operation by either crediting or debiting a buyer account based on the corresponding updated second settlement price;
deliver the second futures contract on or before the second latest possible delivery date by providing the first futures contract to the buyer in exchange for a payment from the buyer of a current second settlement price; and
deliver the first futures contract on or before the first latest possible delivery date by delivering one or the other of the first predetermined amount of the tradable asset to the buyer and a current first settlement price.

18. The system of claim 17, wherein the tradable asset comprises a commodity.

19. The system of claim 18, wherein the commodity comprises crude oil.

20. The system of claim 19, wherein the first futures contract comprises a standard WTI contract.

21. The system of claim 19, wherein the first futures contract comprises a standard Brent contract.

22. The system of claim 17, wherein the second latest possible delivery date occurs one day prior to the first latest possible delivery date.

23. The system of claim 17, wherein the tradable asset comprises at least one asset selected from the group consisting of a stock, a stock index, and a financial index.

24. The system of claim 17, wherein each of the first currency and the second currency is selected from the group consisting of U.S. dollars, European euros, Canadian dollars, U.K. pounds sterling, Australian dollars, New Zealand dollars, Swiss francs, Norwegian kroner, Swedish kronor, and Japanese yen.
